(19) United States
(12) Patent Application Publication
(10) Pub. No.: US 2024/0153283 A1
(43) Pub. Date: May 9, 2024

(54) Driver Monitoring System for a Motor Vehicle

(71) Applicant: Bayerische Motoren Werke Aktiengesellschaft, Muenchen (DE)

(72) Inventors: Manjeet Singh BILRA, Hoerlkofen (Woerth) (DE); Richard KRUEGER, Irschenhausen/Icking (DE)

(21) Appl. No.: 18/279,944

(22) PCT Filed: Feb. 24, 2022
(86) PCT No.: PCT/EP2022/054694

§ 371 Date: Sep. 1, 2023

(30) Foreign Application Priority Data
Mar. 2, 2021 (DE) 10 2021 104 917.2

(51) Int. Cl. G06V 20/59; B60W 50/14

(52) U.S. Cl. CPC G06V 20/597; B60W 50/14; B60W 2420/403; B60W 2540/225

(57) ABSTRACT

A driver monitoring system includes a first control unit, a second control unit, and a camera system. The camera system is configured to acquire image data of a driver and to output information corresponding to the image data to the first and second control units. The first control unit is configured to define a predetermined driver state based on the information received from the camera system and to output the defined driver state to the second control unit. The second control unit is configured to subject the information received from the camera system to a first plausibility check, to subject the driver state received from the first control unit to a second plausibility check, and to output a control signal to an actuator system and/or an information output device based on a result of the first and second plausibility checks and the driver state.

### BACKGROUND AND SUMMARY OF THE INVENTION

The present invention relates to a driver monitoring system for a motor vehicle.

Such driver monitoring systems or devices have a sensor system installed in the vehicle passenger compartment, which sensor system is used to detect data that allow a controller to establish whether a driver is monitoring the vehicle, even when said vehicle is driving automatically, that is to say the transverse and/or longitudinal guidance is taken over by the vehicle.

US 2019/367038 A1 discloses such a driver monitoring device that is provided with a driver monitoring camera, which captures an image of a face of a driver, an acquisition unit, which acquires safety control action information relating to a safety control action of the driver, on the basis of the image of the face of the driver that is captured by the driver monitoring camera, and a determination unit that determines, on the basis of the safety control action information acquired by the acquisition unit, whether or not the driver ignores the safety control action.

Such conventional driver monitoring devices are often not suitable for use in highly automated driving (SAE Level 2 or higher), since their safety or integrity is too low. Standard SAE J3016 in this case describes the classification and definition of terms for road-based motor vehicles having automated driving systems. The classification in turn recognizes six levels (SAE Levels 0 to 5) and describes their minimum requirements. Depending on design and how they are used in a vehicle, it is conceivable to be able to switch between the levels.

The safety requirements for automated driving systems or for driving assistance systems are governed here in accordance with what is known as the Automotive Safety Integrity Level (ASIL), which is a risk classification scheme that is defined in the ISO 26262 standard—Road Vehicles—Functional safety. This classification helps to define the safety requirements that are necessary to meet the ISO 26262 standard. The ASIL requirements are determined by performing risk analysis on a potential hazard by considering severity, exposure and controllability of a respective vehicle operating scenario. The safety objective for this hazard in turn contains the ASIL requirements.

There are four categories that are defined by the ISO 26262 standard: ASIL A, ASIL B, ASIL C and ASIL D. ASIL D prescribes the highest integrity requirements for the system, and ASIL A prescribes the lowest. Hazards that are identified as QM do not prescribe any safety requirements.

Depending on the degree of automation of the vehicle (see the description regarding SAE Level above) and safety relevance of the driving assistance system for performing the automated driving, the driving assistance system has to meet one of the above-described ASIL classifications or ASIL requirements.

By way of example, a driver monitoring system for an SAE Level 2 vehicle which, although it enables automated driving with automated transverse and/or longitudinal guidance, expects that the driver will respond to a request from the vehicle to intervene or to take over transverse and/or longitudinal guidance, has to meet at least ASIL B.

If a driver monitoring system were then to be developed from scratch in accordance with the ISO 26262 standard in order to meet these safety and integrity requirements, this would require a completely new system with hardware and software modifications, which would lead to very high costs and a long development time.

Against the background of this prior art, the object of the present invention is to specify a device that is suitable for overcoming at least the abovementioned disadvantages of the prior art.

The intention is in particular to specify a driver monitoring system that meets the safety requirements applicable to systems for use in highly automated driving and that is based as far as possible on the hardware architecture and/or software architecture of a conventional driver monitoring system.

This object is achieved by the features of the claimed invention.

The object is accordingly achieved by a driver monitoring system for a motor vehicle, wherein the driver monitoring system is provided with a camera system, a first control unit and a second control unit.

The first control unit is connected at input to the camera system and at output to the second control unit.

The second control unit is connected at input to the camera system and to the first control unit and is able to be connected at output to an actuator system and/or an information output device of the motor vehicle.

The actuator system may be a brake and/or a drive device of the motor vehicle. The information output device may be a device for outputting visual signals, such as in particular a display, and/or for outputting acoustic signals, such as in particular a loudspeaker.

The camera system is designed to acquire image data of a driver located on the driver's seat and to output information corresponding to the image data in each case to the first and the second control unit.

The first control unit is designed, based on the information received from the camera system, to define or to determine a predetermined driver state and to output the defined or determined driver state to the second control unit.

The second control unit is designed to subject the information received from the camera system to a first plausibility check, to subject the driver state received from the first control unit to a second plausibility check and, based on a result of the first and second plausibility check and the driver state received from the first control unit, to output a control signal to the actuator system and/or the information output device of the motor vehicle.

The invention is based on the need, described at the outset, to specify a driver monitoring system with safety integrity that is suitable for highly automated vehicles, and offers a solution in which a driver camera already present in the vehicle or a camera system that is already present and a first control unit belonging thereto are able to be qualified with ASIL.

To this end, this known system is modified such that a second control unit checks the plausibility of the data and information output by the first control unit and by the camera system, that is to say checks and thus qualifies said data and information such that they are able to be used to control automated driving, in particular highly automated driving. It is conceivable for the first control unit to be designed as part of the camera or to be integrated into the camera system. It is also conceivable, in addition or as an alternative, for the first and the second control unit to be combined in an electronic control unit (ECU).

It is conceivable for an integrity of the data output by the camera to be checked or inspected as part of the first plausibility check by way of what is known as an end-to-end (E2E) communication protection method. Such a method is known to a person skilled in the art, for example from ISO 26262 or the AUTOSAR standard. In addition or as an alternative, what is known as a cyclic redundancy check (CRC), what is known as alive monitoring, what is known as a rolling frame counter and/or what is known as timeout monitoring may be implemented. Such safety mechanisms are known to a person skilled in the art, for example from the AUTOSAR standard.

It is conceivable, in addition or as an alternative, for one or more, in particular every signal from the camera to be checked using what is known as a “limiter concept”, in which a signal is classified as plausible only when in particular all signal values of the signal lie in a predetermined range. If this is not case, the data delivered by the camera may be classified as not plausible or implausible.

It is conceivable, in addition or as an alternative, for the data output by the camera to be subjected to what is known as a “freeze frame” check as part of the first plausibility check, in which it is checked whether an individual image is static, that is to say an effect is present as though a film has been paused. As soon as such a “freeze frame” is detected, an error flag may be output, that is to say the data output by the camera may be classified as implausible.

It is conceivable, in addition or as an alternative, for what is known as “clock time monitoring” to be performed as part of the first plausibility check, in which a clock or a timestamp that is created by the camera is monitored. A jump and/or a for example constant offset in the data delivered by the camera may in particular be identified here, and these data may thus be classified as implausible.

It is conceivable, in addition or as an alternative, for what is known as a “frame counter” and/or “cycle counter” to be implemented as part of the first plausibility check, which monitor a communication cycle of a communication bus between the camera and the first and/or second control unit.

It is conceivable, in a last step of the first plausibility check, for the data from the first control unit and the data from the second control unit to be input into what is known as a “state machine” in which the data from the two control units are checked against one another before the control signal is output to the actuator system and/or the information output device.

The camera system may be designed to subject the acquired image data of the driver located on the driver's seat to a first safety check.

The first safety check on the image data may comprise a software safety check, for example a defective pixel correction.

The camera system may, in addition or as an alternative, be designed to carry out a hardware safety check, that is to say to monitor for example a system temperature, an input voltage and/or a clock of at least one camera of the camera system that is designed to acquire the image data of the driver located on the driver's seat.

In other words, the camera system may be designed to perform a software and/or hardware safety check. The software safety check in this case concerns the image data captured by the camera system and the hardware safety check concerns the hardware of the camera system, in particular the camera of the system. This has the advantage that faults that occur are already able to be detected in the camera system itself. The camera system may comprise multiple cameras, for example a camera that is arranged substantially centrally in front of the driver. In addition or as an alternative, the camera system may comprise one and/or two cameras that are arranged to the side of the driver.

It is conceivable for the driver monitoring system to be designed to output a control signal to the actuator system of the motor vehicle in order to brake, in particular to stop, said motor vehicle, and/or to output a control signal to the information output device of the motor vehicle in order to bring about outputting of an acoustic signal, in particular a warning noise, when the camera system establishes in the safety check that at least one predetermined safety criterion is not met.

The first control unit may be designed, based on the information received from the camera system, to compute a driver model and, based on the computed driver model, to define the predetermined driver state, in particular comprising a head position, a gaze direction and/or a state of tiredness of the driver, in particular based on pupil monitoring performed on the driver.

It is conceivable for the gaze direction to be determined based on a position of a head of the driver, an orientation of the head of the driver and/or a position of one or both pupils of the driver as determined based on the image data output by the camera system.

It is conceivable for the state of tiredness to be determined based on a time interval, determined on the basis of the image data output by the camera system, in which one or both eyes of the driver are open or closed.

The information output by the camera system may comprise at least information about a position of a head of the driver, an orientation of the head of the driver, information about a position of one pupil or both pupils of the driver and/or information about whether one and/or both eyes of the driver are/is closed or open.

The second control unit may be designed such that it performs the first and the second plausibility check with ASIL B or higher.

It is conceivable for the camera system and/or the first control unit to meet the QM integrity requirements. When the second control unit checks, or checks the plausibility of, its output with ASIL B or higher, the QM data from the first control unit and the camera system are qualified on this integrity level, that is to say ASIL B or higher, and are able to be used for applications in automated driving that require ASIL B or higher.

The second control unit may be designed to end automated transverse and/or longitudinal guidance of the motor vehicle when it is established, in the first and/or the second plausibility check, that the information received from the camera system and/or the driver state received from the first control unit do/does not meet predetermined plausibility criteria.

The second control unit, in addition or as an alternative, may be designed to brake, in particular to stop, the motor vehicle by way of the control signal output to the actuator system, and/or to bring about outputting of an acoustic signal, in particular a warning noise, by way of the control signal output to the information output device of the motor vehicle when it is established, in the first and/or the second plausibility check, that the information received from the camera system and/or the driver state received from the first control unit do/does not meet at least one predetermined plausibility criterion. It is also conceivable, in addition or as an alternative, to visually output warning information, for example comprising a predetermined symbol, a predetermined animation, a predetermined image and/or a predetermined text. A display in a combination instrument and/or a CID (central information display) may for example be used for this purpose.

The second control unit, in addition or as an alternative, may be designed to brake, in particular to stop, the motor vehicle by way of the control signal output to the actuator system, and/or to bring about outputting of an acoustic signal, in particular a warning noise, by way of the control signal output to the information output device of the motor vehicle when it is established, in the first and/or the second plausibility check, that, although the information received from the camera system and/or the vehicle state received from the first control unit meet/meets the predetermined plausibility criteria, the driver state received from the first control unit does not meet predetermined alertness criteria. In other words, when the driver does not meet the alertness required by the driver monitoring system, for example because they are sleeping or not watching the road scene (for example because they are looking sideways), the second control unit may stop the vehicle and/or warn the driver with regard to their excessively low alertness.

The present invention furthermore relates to a method for operating a driver monitoring system as described above for a motor vehicle, and to the employment or use thereof in a motor vehicle.

One embodiment is described below with reference to FIG. 1.

### BRIEF DESCRIPTION OF THE DRAWING

FIG. 1 schematically shows a driver monitoring system for a motor vehicle.

### DETAILED DESCRIPTION OF THE DRAWING

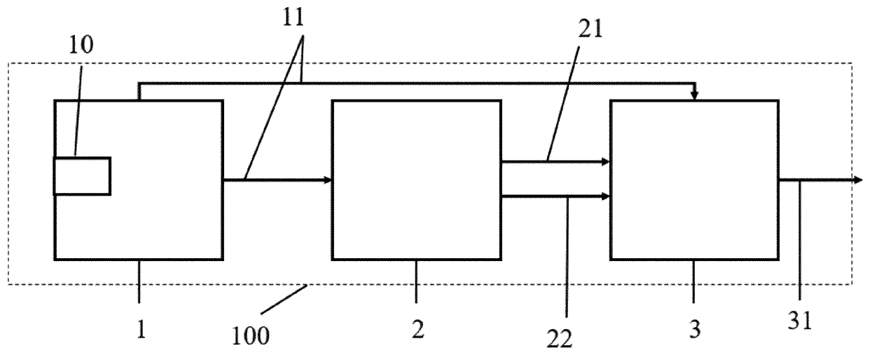

FIG. 1 schematically shows a motor vehicle having a driver monitoring system 100.

The driver monitoring system 100 is a vehicle safety system for monitoring alertness or availability of a driver of the motor vehicle that interacts with driving assistance systems that take over the transverse and/or longitudinal guidance of the motor vehicle. It is conceivable for the driver monitoring system 100 in predetermined cases, for example when the driver is not displaying the required alertness, for example because they are sleeping, to ask the driver to increase their alertness and/or to take over the vehicle guidance by outputting a flashing light and/or a warning noise. If no (sufficient) measures to increase alertness are taken by the driver, it is conceivable for the driver monitoring system 100 to brake the motor vehicle, in particular to bring it to a standstill, and thus avoid any accidents or collisions.

To this end, the driver monitoring system 100 has a camera system 1 having a camera 10, a first control unit 2 and a second control unit 3. The first control unit 2 is connected at input to the camera system 1 and at output to the second control unit 3. The second control unit 3 is connected at input to the camera system 1 and to the first control unit 2 and at output to an actuator system (not illustrated) and/or an information output device (not illustrated) of the motor vehicle.

The camera system 1 is designed to use the camera 10 to acquire or capture image data of the driver located on the driver's seat, in particular their head, eyes and/or pupils, and to output information 11 corresponding to the image data to the first and the second control unit 2, 3.

The information 11 output by the camera system 10 may comprise information about a position of a head of the driver, an orientation of the head of the driver, information about a position of one pupil or both pupils of the driver and/or information about whether one and/or both eyes of the driver are/is closed or open.

The camera system 1 is additionally designed to subject the image data, acquired by the camera 10, of the driver located on the driver's seat to a first safety check, what is known as a software check. This safety check may comprise a defective pixel correction.

The camera system 1 is additionally designed, as part of a hardware check, to monitor a system temperature, an input voltage and/or a clock of the camera 10 of the camera system 1.

If the camera system 1 establishes in either of these, that is to say in the software and/or hardware check, that the camera system 1 does not meet predetermined safety criteria, the driver is asked to take over the vehicle guidance. If this does not take place, or does not take place within a predetermined time, then the driver monitoring system 100 stops the motor vehicle. These safety checks meet the QM requirements.

The first control unit 2 is designed, based on the information 11 received from the camera system 1, to define a predetermined driver state and to output the defined driver state to the second control unit 3.

To this end, the first control unit 2, based on the information received from the camera system 1, computes a driver model and, based on the computed driver model, defines a predetermined driver state, in particular comprising a gaze direction and/or a state of tiredness of the driver.

It is conceivable for example to use the position and orientation of the head and the position of the pupils of the driver to determine in which direction the driver gazes and for how long. If a gaze direction of the driver determined in this way is not directed at the road scene for longer than a predetermined time, for example because the driver is using or reading a smartphone, this may lead to the driver state being classified as excessively low with regard to visual alertness. The result of this classification is output by the first control unit 2 to the second control unit 3 as information 21 describing visual alertness of the driver.

It is also conceivable, in addition or as an alternative, for example using the information as to whether one and/or both eyes of the driver are/is closed or open, for the first control unit 2 to determine whether the driver is asleep or awake. If it is thus established that the driver has their eyes closed for longer than a predetermined time, this may lead to the driver state being classified as asleep. A further subdivision of the driver state into predefined categories is also conceivable, such as in particular awake, uncertain, slightly sleepy, sleepy and falling asleep. The result of this classification is output by the first control unit 2 to the second control unit 3 as information 22 describing sleepiness of the driver.

The information 21 describing visual alertness of the driver and the information 22 describing sleepiness of the driver together form the driver state that is defined by the first control unit 2.

It is also conceivable, in addition to the information described above, for further information to be incorporated into the driver model for determining the driver state or the state of alertness of the driver. By way of example, sleepiness of the driver may be inferred indirectly from operating procedures. One approach is that of monitoring lane keeping between road markings by evaluating images from a further camera (not illustrated) of the camera system 10. This is based on the finding that drivers who are becoming sleepy begin to weave, initially in a barely perceptible manner, between the markings. A further, additional or alternative approach may be that of monitoring steering movements of the driver. Sleepy drivers often make small steering errors and correct these abruptly. Based on these corrections, it is conceivable for the first control unit, possibly in connection with the gaze behavior of the driver, a time of day and/or a speed of the motor vehicle, to compute a degree of tiredness.

The driver state thus defined by the first control unit 2 meets the QM requirements here.

The second control unit 3 is designed to subject the information 11 received from the camera system 1 to a first plausibility check, to subject the driver state received from the first control unit 2 to a second plausibility check and, based on a result of the first and second plausibility check and the driver state received from the first control unit 2, to output a control signal 31 to the actuator system and/or the information output device of the motor vehicle. The second control unit 3 is in this case designed such that it performs the first and the second plausibility check with ASIL B or higher.

Depending on the result of the first and second plausibility check, the driver monitoring system 100 outputs the control signal 31 in various ways, which is described in detail below.

The second control unit 3 is designed to end automated transverse and/or longitudinal guidance of the motor vehicle when it is established, in the first and/or the second plausibility check, that the information received from the camera system 1 and/or the driver state received from the first control unit 2 do/does not meet predetermined plausibility criteria.

The second control unit 3 is designed in particular to brake, in particular to stop, the motor vehicle by way of the control signal 31 output to the actuator system 3, and/or to bring about outputting of an acoustic signal, in particular a warning noise, by way of the control signal 31 output to the information output device of the motor vehicle when it is established, in the first and/or the second plausibility check, that the information 11 received from the camera system 1 and/or the driver state received from the first control unit 2 do/does not meet predetermined plausibility criteria.

The second control unit 3 is furthermore designed to brake, in particular to stop, the motor vehicle by way of the control signal 31 output to the actuator system 3 and/or to bring about outputting of an acoustic signal, in particular a warning noise, by way of the control signal 31 output to the information output device of the motor vehicle when it is established, in the first and/or the second plausibility check, that the information 11 received from the camera system 1 and/or the driver state received from the first control unit 2, although they/it meet/meets predetermined plausibility criteria, the driver state received from the first control unit 3 does not meet predetermined alertness criteria.

### LIST OF REFERENCE SIGNS

1 camera system
10 camera
11 information based on image data from the camera
2 first control unit
21 information describing visual alertness of the driver
22 information describing sleepiness of the driver
3 second control unit
31 control signal output by the second control unit
100 driver monitoring system

1.-10. (canceled)

11. A driver monitoring system for a motor vehicle, the driver monitoring system comprising:
a camera system;
a first control unit; and
a second control unit, wherein
the first control unit is connected at input to the camera system and at output to the second control unit,
the second control unit is connected at input to the camera system and to the first control unit and is connectable at output to an actuator system and/or an information output device of the motor vehicle,
the camera system is configured to acquire image data of a driver located on a driver's seat and to output information corresponding to the image data to the first control unit and the second control unit,
the first control unit is configured, based on the information received from the camera system, to define a predetermined driver state and to output the driver state to the second control unit, and
the second control unit is configured to subject the information received from the camera system to a first plausibility check, to subject the driver state received from the first control unit to a second plausibility check and, based on a result of the first plausibility check, the second plausibility check and the driver state received from the first control unit, to output a control signal to the actuator system and/or the information output device of the motor vehicle.

12. The driver monitoring system according to claim 11, wherein the camera system is further configured to subject the image data of the driver located on the driver's seat to a first safety check.

13. The driver monitoring system according to claim 12, wherein the first safety check comprises a software safety check.

14. The driver monitoring system according to claim 13, wherein the software safety check is a defective pixel correction.

15. The driver monitoring system according to claim 11, wherein the camera system is further configured to monitor a system temperature, an input voltage and/or a clock of at least one camera of the camera system that is configured to acquire the image data of the driver located on the driver's seat.

16. The driver monitoring system according to claim 11, wherein the first control unit is further configured, based on the information received from the camera system, to compute a driver model and, based on the computed driver model, to define the driver state.

17. The driver monitoring system according to claim 16, wherein the driver state comprises a gaze direction and/or a state of tiredness of the driver.

18. The driver monitoring system according to claim 11, wherein the information output by the camera system comprises at least information about a position of a head of the driver, information about an orientation of the head of the driver, information about a position of one pupil or both pupils of the driver and/or information about whether one and/or both eyes of the driver are/is closed or open.

19. The driver monitoring system according to claim 11, wherein the second control unit is further configured such that the second control unit performs the first plausibility check and/or the second plausibility check with ASIL B or higher.

20. The driver monitoring system according to claim 11, wherein the second control unit is further configured to end automated transverse and/or longitudinal guidance of the motor vehicle upon establishment, in the first plausibility check and/or the second plausibility check, that the information received from the camera system and/or the driver state received from the first control unit do/does not meet at least one predetermined plausibility criterion.

21. The driver monitoring system according to claim 11, wherein the second control unit is further configured to brake the motor vehicle by way of the control signal output to the actuator system, and/or to bring about outputting of an acoustic signal by way of the control signal output to the information output device of the motor vehicle upon establishment, in the first plausibility check and/or the second plausibility check, that the information received from the camera system and/or the driver state received from the first control unit do/does not meet at least one predetermined plausibility criterion.

22. The driver monitoring system according to claim 21, wherein the acoustic signal is a warning noise.

23. The driver monitoring system according to claim 11, wherein the second control unit is further configured to stop the motor vehicle by way of the control signal output to the actuator system, and/or to bring about outputting of an acoustic signal by way of the control signal output to the information output device of the motor vehicle upon establishment, in the first plausibility check and/or the second plausibility check, that the information received from the camera system and/or the driver state received from the first control unit do/does not meet at least one predetermined plausibility criterion

24. The driver monitoring system according to claim 11, wherein the second control unit is further configured to brake the motor vehicle by way of the control signal output to the actuator system, and/or to bring about outputting of an acoustic signal by way of the control signal output to the information output device of the motor vehicle upon establishment in the first plausibility check and/or the second plausibility check, that the information received from the camera system and/or the driver state received from the first control unit meet/meets all predetermined plausibility criteria, and the driver state received from the first control unit does not meet predetermined alertness criteria.

25. The driver monitoring system according to claim 24, wherein the acoustic signal is a warning noise.

26. The driver monitoring system according to claim 11, wherein the second control unit is further configured to stop the motor vehicle by way of the control signal output to the actuator system, and/or to bring about outputting of an acoustic signal by way of the control signal output to the information output device of the motor vehicle upon establishment in the first plausibility check and/or the second plausibility check, that the information received from the camera system and/or the driver state received from the first control unit meet/meets all predetermined plausibility criteria, and the driver state received from the first control unit does not meet predetermined alertness criteria.
